(19) United States
(12) Patent Application Publication
(10) Pub. No.: US 2016/0316777 A1
(43) Pub. Date: Nov. 3, 2016

(54) QUARK BASED FAT MIXTURE COMPRISING PLANT OIL AND A PROCESS FOR PRODUCING IT

(71) Applicant: VALIO OY, Valio (FI)

(72) Inventor: Ilona KÖCKRITZ-PERKIÖ, Vantaa (FI)

(73) Assignee: VALIO OY, Valio (FI)

(21) Appl. No.: 15/101,274

(22) PCT Filed: Dec. 8, 2014
(86) PCT No.: PCT/FI2014/050963

§ 371 Date: Jun. 2, 2016

(30) Foreign Application Priority Data
Dec. 9, 2013 (FI) 20136238

(51) Int. Cl. A23D 7/005; A23C 19/093; A23C 19/076

(52) U.S. Cl. CPC A23D 7/0053; A23C 19/076; A23C 19/093

(57) ABSTRACT

The invention relates to a process for the manufacture of a fat mixture, where said process comprises the steps where in the first step 60-95 wt % of quark, and 5-40 wt % of milk base are mixed to obtain a quark blend, in the second step 9-62 wt % of at least one edible plant oil, is added to 38-91 wt % of the quark blend, followed by mixing to obtain the fat mixture. The invention also relates to a fat mixture obtainable by said process and to uses of said fat mixture in food products.

### FIELD OF THE INVENTION

The present invention relates to fat mixtures, particularly to emulsions comprising milk derived components and oil, and to a process for producing said fat mixtures. Said fat mixtures are suitable as food products, particularly such as dressings, sauces, toppings, glazings, puddings, gravies, seasoning sauces and the like.

### BACKGROUND OF THE INVENTION

Conventionally, dressings, sauces, toppings, glazings, puddings, gravies and the like contain egg or egg constituents to emulsify the oil or fat contained in said products, and to obtain a stable product. Typically also various additives are included in said products for improving their properties. Egg has excellent functional properties and thus it is widely used particularly in food products where emulsions are required.

For example mayonnaise type products, typically comprising from 60 to 85 wt % of oil, contain egg yolk or whole egg for emulsifying the oil, and for obtaining a stable product having a continuous aqueous phase and a dispersed oil phase.

However, egg also has some disadvantages. It has high cholesterol content. It suffers from microbial complications. Because of this, vulnerable groups of the population are often advised to avoid the consumption of raw egg and products including raw egg. Although the microbial profile can be improved by selective heat treatment, such treatment may adversely affect the functional properties of the egg. The shelf life of functional egg components tends to be short. Moreover, there is a group of people with serious allergic reaction to egg protein. Furthermore, some vegetarians do not wish to consume products that contain egg or egg components.

Several alternative egg extenders, egg replacers and compositions without egg have been proposed in the art. However, in products in the form of emulsions, such as mayonnaise, the functional contribution of egg is difficult to replace. When egg yolk is replaced with low molecular weight emulsifiers, such as ethoxylated monoglycerides, diacetyl tartaric acid ester of mono- and diglycerides or hydrolyzed lecithins, oil-in-water emulsion are obtained with low viscosity. Polyoxyethylene-(20)-sorbitan monostearate at concentrations higher than 1% provides high viscosity emulsions, but the taste is bitter and unacceptable. Viscosity may also be increased with thickening agents, such as gums, polysaccharides etc., but typically poor texture and/or poor stability is achieved, particularly with high fat emulsions.

High molecular weight emulsifiers have also been proposed as well as acidified protein solutions. In proteins random coiled structures like the ones in casein and skim milk powder precipitate upon direct acidification and thereby proteins lose their emulsifying properties. Proteins with generally compact and inflexible structure, such as whey, soy and pea proteins are mixtures of different types of serum albumins and globulins. They provide in most cases emulsification to yield high viscosity emulsions but said emulsions typically become gelatinized during storage and result in rough texture.

An egg-free mayonnaise-like product is disclosed in EP 0788747 A1, said product comprising from 55 to 85% of fat (plant oil), at least 0.1% of milk proteins selected from skim milk, buttermilk, casein and whey proteins, or of vegetable proteins, where said proteins are denaturated at a degree between 70 and 80%, at least 1% of sugar, 0.5% of salt and 0.1-20% of vinegar. Said product has a pH between 2 and 5. Further, 0.01-2% of low molecular weight emulsifiers selected from monoglycerides, ethoxylated monoglycerides, polyoxyethylene-sorbitans, mono- and diesters of higher fatty acids and glycerin may be used. The denaturation is accomplished by heating the mixture, for example indirectly with steam at 85° C. for 5 minutes, followed by cooling, acidification and homogenizing.

WO 2007/054199 A1 relates to an egg-free mayonnaise-type product having a continuous aqueous phase and a dispersed oil phase. Said product comprises 25-87 wt % of oil and 0.5-15 wt % of a combination of soy protein and whey protein. Said product may also contain an emulsifier, such as lecithin, polyoxy derivative of fatty acid, a thickener, such as gums and starches, and an acid.

Quark is unripened fresh cheese which is typically made from pasteurized skim milk by adding an acidifier to the milk. Often also a small amount of rennet is added. An acid curd is formed which is typically separated from whey solution by means of separators. Quark has a smooth texture and mild, acid flavor. Quark can be flavored or blended with fruits, nuts, etc., and is typically used in cooking, in baking, in confectionery products and as a dessert.

There is an evident need for stable emulsions containing significant amounts of fat and proteins derived from milk, said emulsions having pleasant texture and mouth feel, without egg and complicated mixtures of additives, as well as for a process for the manufacture of said emulsions.

### SUMMARY OF THE INVENTION

The present invention relates to a fat mixture comprising proteins, plant oil and water. Suitably the fat mixture comprises 1-12 wt % of proteins (total amount), 9-62 wt % of edible plant oil, and at least 50 wt % of said proteins comprise casein and 0.1-10 wt % of said proteins comprise native whey proteins,. The fat mixture has pH of 3-6.5.

The present invention relates also to a process for the manufacture of a fat mixture, said process comprising the steps where,

in the first step 60-95 wt % of quark and 5-40 wt % of milk base, total amount of milk base, are mixed to obtain a quark blend, said percentages being calculated from the quark blend, in the second step 9-62 wt % of edible plant oil, calculated from the total weight of the fat mixture, is added to 38-91 wt % of the quark blend, calculated from the total weight of the fat mixture, followed by mixing to obtain the fat mixture, and where 0-50 wt % of the quark is replaced with casein concentrate.

According to another embodiment, the present invention relates to food products comprising the fat mixture.

According to another embodiment, the present invention relates to the use of the fat mixture in the manufacture of food products.

Thus an object of the invention is to provide a fat mixture having high protein content, which fat mixture is egg-free and cholesterol-free, stable and has good organoleptic properties.

Another object of the invention is to provide a process for the manufacture of said fat mixture.

Still another object of the invention is to provide egg-free and cholesterol-free fat mixtures and emulsions, for use as food products or as components in food products.

Characteristic features of the invention are defined in the appended claims.

### DEFINITIONS

The term “egg-free” means here that the product does not contain egg-proteins, material originating from egg yolk, or constituents originating from eggs.

The term “cholesterol-free” means here that the product contains preferably no cholesterol, or at most 0.01 wt % of cholesterol.

The term “butterfat” refers here to all fats originating from milk.

The term “native protein” refers here to non-denatured protein.

The term “casein” refers here to a group of phosphoproteins. Casein is derived from milk. The term “casein” comprises also acid casein, rennet casein, hydrolyzed casein, sodium caseinate, potassium caseinate, magnesium caseinate, calcium caseinate, and combinations thereof.

In an embodiment of the invention, the casein-containing material is microfiltration retentate or ultrafiltration retentate (casein concentrate). In an embodiment the microfiltration retentate is concentrated by ultrafiltration.

In another embodiment, the casein-containing material is milk or quark.

As used herein, the term “milk” means any normal secretion obtained from the mammary glands of mammals, such as cow's, goat's, camel's, horse's or sheep's milk, or any other animal producing milk suitable for nourishment.

The term “whey protein” refers here to proteins present in milk permeate, acid whey, and cheese whey, such as quark and/or cottage cheese whey. Examples of whey proteins are α-lactalbumin and β-lactoglobulin.

The term “milk-permeate” refers here to permeate comprising whey proteins that can be produced from one or more of the fractions obtained by means of membrane techniques. Two or more membrane techniques can be combined including microfiltration, diafiltration, ultrafiltration, nanofiltration and reverse osmosis, in an appropriate manner.

The term “ideal whey solution” or “ideal whey” or “ideal whey protein solution” is used herein to mean microfiltration (MF) permeate obtained from microfiltration of milk. The term(s) is understood to encompass also a concentrated form of the MF permeate which is obtained as an ultrafiltration retentate from ultrafiltration of the MF permeate. The ideal whey protein solution may contain β-casein in addition to whey proteins. It does not contain fat, other micellar casein monomers or any other by-products from the cheese manufacture. Further, it is free of caseinomacropeptides and thermally formed κ-casein β-lactoglobulin complexes.

Ideal whey solution may be prepared by microfiltration of non-acidified milk base whereby the ideal whey solution is obtained as microfiltration permeate (MF-permeate). Microfiltration is typically carried out at a temperature from about 2° C. to about 55° C. Microfiltration may be performed by means of diafiltration to enhance the separation of whey proteins from casein included in milk. The concentration factor in the microfiltration can range from about 1 to about 70. The size of the microfiltration membrane is typically in the range of about 0.05 to about 0.5 μm. The microfiltration permeate may be concentrated by ultrafiltration, whereby the ideal whey protein solution is obtained as an ultrafiltration retentate (UF-retentate). Ultrafiltration is typically performed at about 5° C. to about 55° C. The concentration factor in the ultrafiltration can range from about 10 to about 115.

The protein content of the ideal whey solution can range from about 4% to about 25%. In an embodiment, the protein content of the ideal whey solution is about 5-15%.

### BRIEF DESCRIPTION OF THE DRAWINGS

FIG. 1 shows a schematic flow diagram representing an embodiment of the process of the invention for the manufacture of the fat mixture.

### DETAILED DESCRIPTION OF THE INVENTION

The invention is based on the idea of obtaining fat mixtures and particularly emulsions from milk derived fractions comprising proteins and edible plant oils, without additional emulsifiers or thickeners, with a simple and economic process. Fat mixtures and particularly emulsions are obtained, having good stability, pleasant texture, mouth feel and appearance, said fat mixtures being suitable for a wide range of food products and applications. Accordingly fat mixtures and particularly emulsions may be obtained, having a continuous aqueous phase and a dispersed oil phase (oil-in-water).

The process of the invention, for the manufacture of a fat mixture comprises the steps, where in the first step 60-95 wt % of quark and 5-40 wt % of milk base, calculated as total milk base, are mixed to obtain a quark blend, said percentages being calculated from the quark blend, in the second step 9-62 wt % of edible plant oil, calculated from the total weight of the fat mixture, is added to 38-91 wt % of the quark blend, calculated from the total weight of the fat mixture, followed by mixing to obtain the fat mixture, and where 0-50 wt % of the quark is replaced with casein concentrate.

### Quark

Quark is a milk derived product. Quark, suitable for use in the process of the present invention comprises 8-12 wt %, preferably 10-11% of total proteins. Said proteins comprise 70-100 wt %, preferably 80-100 wt % of casein, and 0-30 wt %, preferably 0-20 wt % of whey proteins. Quark comprises not more than 2%, preferably not more than 0.3 wt %, of butterfat, 0-5 wt %, preferably 0.01-4.3 wt % of lactose and it has a pH of 3-6, preferably of 4-5.

### Manufacture of Quark

Said quark may be manufactured using any method suitable for the manufacture of quark. Several methods are known in the art. In the manufacturing method typically milk raw material is subjected to heat treatment and/or pasteurization followed by adding coagulant to the heat treated milk raw material, whereby acid curd is formed, and mixing the acid curd. If desired, whey solution may be separated from the acid curd, or alternatively the mixture comprising the acid curd and whey solution may be sieved. The product obtained in both cases is quark (quark mass).

The milk raw material useful in the manufacture of quark is selected from milk, recombined skim milk powder, microfiltrated milk, ultrafiltrated milk, diafiltrated milk, organic milk or combination of these or dilution of any of these. The milk raw material may optionally be standardized with respect to fat, protein and/or lactose content, and it may be optionally pretreated for microbial removal, using methods known as such, i.e. microfiltration, bactofugation etc.

Suitably the fat content (butterfat) in the milk raw material is not more than 2 wt %, preferably not more than 0.3 wt %.

The heat treatment and pasteurization of said milk raw material may be carried out in a similar manner as instructed in connection with the manufacture of milk base later in this specification.

At least one coagulant is added to the heat treated and optionally cooled milk raw material. Coagulation (curdling) means here simultaneous clotting and gel forming, effected by the action of one or more coagulants. The coagulant may be a coagulant selected from chemical and biological acidifiers, or a physical coagulant selected from rennets and chymosin, or any combination of said coagulants.

Any acidifier commonly used in the preparation of acidified milk products can be used in the method for the manufacture of quark. The acidifier is selected from biological acidifiers and chemical acidifiers. Biological acidifiers are typically ferments, starters, DVS starters (direct to vat starter), for instance mesophilic starters (Lactococcus lactis ssp. cremoris, Lactococcus lactis ssp. lactis, Leuconostoc mesenteroides ssp. cremoris and Lactococcus lactis ssp. diacetylactis), or thermophilic starters (Streptococcus thermophiles, Lactobacillus delbrueckii susp. Bulgaricus). Chemical acidifiers are selected from acidogens, organic acids and inorganic acids, such as glucono-delta-lactone, lactic acid, citric acid, hydrochloric acid, oxalic acid, tartaric acid, fumaric acid, succinic acid, malic acid, gluconic acid, adipic acid, and phytic acid, optionally with added calcium salt. Suitably at least one starter is used, optionally together with rennet or chymosin. Said rennet or chymosin is suitably added after the pH of the reaction mixture has started to decrease.

If desired, lactose-free quark or low-lactose quark may be produced. Any suitable lactase enzyme may be added simultaneously or subsequently with the coagulant. The amount of the lactase enzyme is typically 0.001-1 wt %.

After the coagulant(s) and optional lactase enzyme is added, coagulation, acidification, optional lactase treatment and ripening take place whereby acid curd is formed and curd mixture is obtained.

The temperature at which coagulation, acidification, lactase treatment and ripening are carried out can vary within the range of 20 to 45° C., depending on the specific acidifier (starter) and enzyme used in the method. Typically the ripening is allowed to proceed until the pH is in the range of 4.2-5.2. The ripening time may range from 2 to 25 hours, depending on the coagulant, temperature etc.

The curd mixture is mixed with any suitable mixers, such as homogenizers, jet mixers, jet mixing turbines, agitators etc.

Optionally the curd mixture is thermized (heat treated). The curd mixture (comprising the acidified milk raw material) is suitably heat treated prior to optional sieving in order to enhance the adhesion of the whey proteins to casein. Thermization can be carried out at conditions used in the preparation of quark products. Thermization is typically performed at about 55 to about 68° C. for about 5 to about 20 minutes. The thermization is followed by cooling the curd mixture, suitably to a separation temperature prior to sieving and optional separation steps.

The curd mixture, which is optionally subjected to thermization may be subjected to optional sieving. The optional sieving of the curd mixture is conducted in a manner known in the field.

The curd mixture, optionally subjected to one or more of heat-treating, cooling, and sieving steps may be subsequently subjected to an optional separation step in which quark mass is separated from an acid solution containing milk minerals and optional lactase enzyme. The separation can be effected by a quark separator typically used in the production of quark products. The quark mass can also be separated by ultrafiltration where quark mass comprising whey proteins is retained in the ultrafiltration retentate and the solution is passed through a membrane as permeate. For example, a plate & frame ultrafiltration apparatus can be used. The separation is carried out under the conditions, such as temperature, commonly used in the preparation of quark. The quark mass may finally be cooled.

The quark (quark mass obtained as curd mixture or obtained after separation of solution) typically contains totals solids of about 10 to about 28 wt %, preferably about 12-18 wt %.

### Milk Base

The milk base is selected from non-acidified milk bases, acidified milk bases and combinations thereof.

The non-acidified milk base suitably comprises skim milk, UF-milk (ultra-filtrated milk concentrate), NF-milk (nano-filtrated milk concentrate), UF-retentate, NF-retentate, ideal whey solution or other milk base material containing approximately same amounts of native whey proteins as the non-acidified milk base materials listed above, or combinations thereof. UF-milk typically comprises casein and whey proteins in a ratio from 75:25 to 80:20. Said non-acidified milk base may further comprise whey protein concentrate and/or whey protein isolate for adjusting the whey protein content in the milk base to the desired range.

According to one preferable embodiment the milk base comprises 50-80 wt % of UF-milk and 20-50 wt % of skim milk.

In an embodiment the UF-milk comprises 5-15 wt % protein (total). The UF-milk has protein composition similar to milk i.e. it comprises casein and whey proteins in a ratio from 75:25 to 80:20 but less non-protein nitrogen than fresh milk.

According to another embodiment the milk base consists of milk MF-permeate (ideal whey solution).

According to still another embodiment the milk base consists of UF-retentate (milk MF-permeate concentrated by ultrafiltration).

The milk base may optionally be standardized with respect to fat, protein and/or lactose content, and it may be optionally pretreated for microbial removal, using methods such as microfiltration or bactofugation. Suitably the fat (butterfat) content in the milk base is less than 2%, preferably not more than 0.3 wt %.

The milk base may be non-acidified or alternatively acidified milk base, or a combination thereof. Preferably the milk base is acidified milk base having pH in the range of 4-6, preferably 4.8-5.2, more preferably 4.9-5.1.

The milk base comprises 0.6-10 wt %, preferably 1.4-7 wt %, more preferably 1.4-3.4 wt % of native, non-denatured whey proteins.

### Manufacture of Milk Base

Non-acidified milk base can be obtained by mixing milk base materials as listed above (non-acidified milk bases). In the case only one milk base material is used, it may be used as such or it may be subjected to mixing for providing homogeneous non-acidified milk base.

Acidified milk base may be manufactured with a method where the non-acidified milk base is subjected to heat treatment, followed by acidification where at least one acidifier is added to the heat treated non-acidified milk base, whereby acidified milk base is obtained.

Optionally whey protein concentrate and/or whey protein isolate may be added to the milk base for increasing the whey protein content. In the manufacture of acidified milk base whey protein concentrate and/or whey protein isolate may be added prior to the heat treatment.

In an embodiment the whey protein concentrate comprises 5-25 wt % of protein (total), preferably 8-15 wt % of protein (total).

In the manufacture of the acidified milk base the heat treatment is carried out at a temperature ranging from about 57 to about 138° C., typically for about 1 s to about 15 min. The heat treatment may comprise one or more heat treatment steps and the heat treatment may also be a combination of different heat treatment techniques. Examples of heat treatment techniques useful in the method are pasteurization, high pasteurization (such as 95° C., 5 min), heating at a temperature lower than the pasteurization temperature for a sufficiently long time, thermization, (such as heating for 2 s to 3 min at approximately 57 to 68° C.), UHT treatment (such as heating at 138° C., 2 to 4 s), ESL treatment (such as heating at 130° C., 1 to 2 s) can be mentioned. The heat treatment can be either direct (vapor to milk, milk to vapor) or indirect (tube heat exchanger, plate heat exchanger, scraped-surface heat exchanger).

According to one embodiment the pasteurization may be carried out at a temperature ranging from about 80 to about 95° C., typically for about 5 s to about 15 min. According to another embodiment the pasteurization may be carried out at a temperature of 84-87° C., typically for about 3 to 7 min.

The above described heat treatment and pasteurization methods may be used as well in the manufacture of quark, described in this specification earlier.

Optionally cooling is carried out after the heat treatment step. The heat treated milk base may be cooled to a temperature of 27-35° C., preferably to a temperature of 27-32° C. Any suitable cooling apparatus may be used, such as heat exchangers etc.

The acidifier is added to the heat treated and optionally cooled milk base. The amount of the acidifier may range between 0.01 and 3%, calculated from the total weight of mixture.

Any acidifier commonly used in the preparation of acidified milk products can be used in the method of the present invention. The acidifier is selected from biological acidifiers and chemical acidifiers. Biological acidifiers are typically ferments, starters, DVS starters (direct to vat starter), for instance mesophilic starters (Lactococcus lactis ssp. cremoris, Lactococcus lactis ssp. lactis, Leuconostoc mesenteroides ssp. cremoris and Lactococcus lactis ssp. diacetylactis), or thermophilic starters (Streptococcus thermophiles, Lactobacillus delbrueckii susp. Bulgaricus). Chemical acidifiers are selected from acidogens, organic acids and inorganic acids, such as glucono-delta-lactone, lactic acid, citric acid, hydrochloric acid, oxalic acid, tartaric acid, fumaric acid, succinic acid, malic acid, gluconic acid, adipic acid, and phytic acid, optionally with added calcium salt.

If desired a lactose-free or low-lactose product may be produced. Any suitable lactase enzyme may be added simultaneously or subsequently with the acidifier. The amount of the lactase enzyme is typically 0.001-1 wt %.

After the acidifier(s) and optional lactase enzyme is added, acidification, optional lactase treatment and ripening take place whereby acidified milk base is obtained.

The temperature at which acidification, lactase treatment and ripening are carried out can vary within the range of about 20 to about 45° C., depending on the specific acidifier (starter) and enzyme used in the method. In an embodiment, the temperature is 35-45° C. According to another embodiment the temperature is 35-39° C. Typically the ripening is allowed to proceed until the pH is in the range of 4.2-5.2. The ripening time may range from 2 to 25 hours, depending on the acidifier, temperature etc.

Optionally the acidified milk base is subjected to mixing with suitable mixers, such as jet mixers, agitators or the like or using techniques and equipment normally used in the manufacturing of edible fats and oil products, and milk products. Preferably the acidified milk base is subjected to mixing with a blender or a high-shear mixer typically used in the field.

Optionally the acidified milk base is cooled to a temperature of 10-20° C.

Manufacture of the Fat Mixture The process for the manufacture of a fat mixture comprises the steps, where in the first step 60-95 wt % of quark and 5-40 wt % of milk base, calculated as total milk base, are mixed to obtain a quark blend, said percentages being calculated from the quark blend, in the second step 9-62 wt % of edible plant oil, calculated from the total weight of the fat mixture, is added to 38-91 wt % of the quark blend, calculated from the total weight of the fat mixture, followed by mixing to obtain the fat mixture, where 0-50 wt % of the quark is replaced with casein concentrate.

The casein concentrate may be added as such to the quark or quark blend or it may be mixed with milk base first. The milk base may be part of the milk base mixed with the quark, or a different milk base. Preferable the same milk base is used. The amount of the milk base is included in the total milk base amount.

Preferably, in the first step 70-75 wt % of quark is used.

In the first step preferably 0-30 wt % of the quark is replaced with casein concentrate.

The casein concentrateis preferably acidified, as instructed in connection with milk base above. Suitably the casein concentrate is blended with the milk base and then acidified.

The casein concentrate refers here to milk MF-retentate obtained from microfiltration of milk (preferably skim milk). It comprises 5-20 wt % of protein, typically it comprises 5-11 wt % of protein (typically 8-10 wt % of casein and traces of denatured whey proteins)

In the first step preferably 25-30 wt % of the milk base is mixed with the quark. In the second step preferably 44-60 wt % of edible plant oil is used. In the second step the edible plant oil is added to preferably 40-56 wt % of the quark blend.

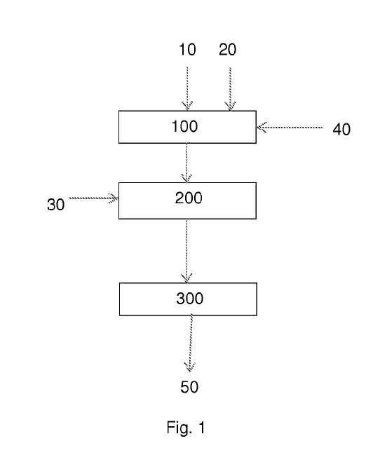

In FIG. 1 a schematic flow diagram is shown, illustrating an embodiment of the process of the invention for the manufacture of the fat mixture. Quark 10 and milk base 20 are mixed in a mixer 100 to obtain a quark blend, and pH and temperature are adjusted if necessary. Plant oil 40 is added to the quark blend and the mixture is then agitated/homogenized in a homogenizer 200, optional flavors and additives 30 are added and the mixture is agitated/homogenized to obtain a smooth mixture, which is directed to packaging device 300 to obtain products packages 50.

The process may be carried out as a batch process, semi-continuous process or continuous process. According to one embodiment the plant oil (oils) is added as a continuous feed in one step or preferably in two or more steps, where each step is followed by vigorous mixing. Preferable said mixing is carried out as high shear mixing. Inline high shear mixers are particularly suitable for producing said fat mixtures on an industrial scale.

The milk base is selected from non-acidified and acidified milk bases and any combinations thereof.

According to a preferable embodiment the non-acidified milk base comprises at least two components selected from skim milk, UF-retentate and ideal whey solution, where the amount of skim milk is 0-50 wt %, the amount of UF-retentate is 0-60 wt %, and the amount of ideal whey solution is 0-60 wt %, and any mixtures thereof. The pH of the non-acidified milk base is approximately 6-7.

According to a preferable embodiment the acidified milk base comprises 35-45 wt % of skim milk and 55-65 wt % of UF milk concentrate. UF milk concentrate contains all milk proteins.

The pH of the acidified milk base is 4-6, preferably 4.8-5.2, more preferably 4.9-5.1.

The quark is mixed with the first milk base suitably at a temperature below 20° C. using mixing devices generally used in the field, such as dynamic or static mixers.

The plant oil is selected from any edible plant oils, preferably from sunflower oil, rapeseed oil, soy bean oil, cotton seed oil, palm kernel oil, peanut oil, olive oil, maize oil, corn oil, walnut oil, sesame oil, linseed oil, avocado oil, pecan oil, colza oil, almond oil, camelina oil, safflower oil, hempseed oil, pumpkin seed oil and any combinations thereof.

The edible plant oil is mixed with the quark blend, where optionally part of the quark is replaced with casein concentrate or a second milk base comprising casein concentrate, to obtain a mixture and the mixture is mixed vigorously in mixing device. Suitable mixing devices are homogenizers, jet mixers, jet mixing turbines, emulsifiers, high shear emulsifiers, power blenders and the like, which are able to provide emulsification and homogenization.

The mixing of the plant oil with the quark blend may be carried out at moderate temperatures, suitably at temperatures from 2-30° C., preferably 2-18° C. In a specific embodiment the mixing temperature oil is 10-23° C.

The pH of the mixture is optionally adjusted to 3-6.5. In a specific embodiment the pH of the mixture is optionally adjusted to 4.5-6.5.

In one embodiment the pH of the quark blend is optionally adjusted to 4-6.5 followed by addition of edible plant oil in two or more stages, each stage followed by high shear mixing.

A smooth homogeneous fat mixture (fat emulsion) is obtained.

Optional additives may be added to the obtained mixture, followed by mixing, or alternatively during the mixing of the plant oil with the quark blend. Said additives may be selected from salt, sweeteners (such as sugar, corn syrup, maltodextrins, dextrose, saccharine, acesulfame, sucralose, stevia alcaloids, aspartame, sugar alcohols, etc.), acetic acid, vinegar, aromas, spices, flavors (such as vanilla, hazelnut, irish crème, mocha, almond, liqueurs, chocolate, berry, fruit etc.), seasonings, cocoa, mustard, coloring agents, tomato, sweet pepper, vitamins, antioxidants (such as ethoxyquin, vitamin E, BHA, BHT, TBHQ, ascorbyl palmitate), preservatives (such as sorbates, benzoates etc.) and the like.

The pH of the product (fat mixture) may optionally be adjusted to 3-6.5 with vinegar, acidified milk base, lemon juice, lactic acid, citric acid, hydrochloric acid, oxalic acid, tartaric acid, fumaric acid, succinic acid, malic acid, gluconic acid, adipic acid, phytic acid or another food grade acid, and any combinations thereof.

### Fat Mixture

The fat mixture is a high protein, egg-free and cholesterol-free emulsion product derived from milk and comprising preferably little or no butter fat. Said mixture is typically an emulsion having a continuous aqueous phase and a dispersed oil phase.

The fat mixture comprises 1-12 wt %, preferably 2-10 wt % of proteins calculated as the total amount of proteins.

In the fat mixture at least 50 wt % of said proteins comprises casein.

The fat mixture comprises 0.1-106 wt %, preferably 0.2-4 wt % of native whey proteins. Suitably said native whey proteins comprise β-lactoglobulin and α-lactalbumin.

In an embodiment of the invention, the proteins (total proteins) comprise 90-96 wt %, preferably 93-96 wt % of casein.

Said proteins may comprise additionally denatured whey proteins.

The fat mixture comprises 9-62 wt %, preferably 44-60 wt % of edible plant oil.

The fat mixture comprises preferably 34-80 wt %, more preferably 40-60 wt % of water.

The fat mixture comprises 0-2 wt %, preferably not more than 0.3 wt % of butterfat.

The fat mixture comprises 0-5 wt %, preferably 0.005-4.3 wt % of lactose.

The pH of the fat mixture is 3-6.5, preferably 4.5-6.

The fat mixture or emulsion may also comprise one or more additives. Said additives may be selected from salt, sweeteners (such as sugar, corn syrup, maltodextrins, dextrose, saccharine, acesulfame, sucralose, stevia alcaloids, aspartame, sugar alcohols, etc.), acetic acid, vinegar, aromas, spices, flavors (such as vanilla, hazelnut, irish crème, mocha, almond, liqueurs, chocolate, berry, fruit etc.), seasonings, cocoa, mustard, coloring agents, tomato, sweet pepper, vitamins, antioxidants (such as ethoxyquin, vitamin E, BHA, BHT, TBHQ, ascorbyl palmitate), preservatives (such as sorbates, benzoates etc.) and the like.

No additional emulsifiers or thickening agent are needed in the product.

The product has very pleasant texture, structure, nice gloss, mouth feel and appearance, and good stability. The natural color of the fat mixture is white, however the color may differ from white depending on the color of the oil used. No membrane (skin or peel) is formed on the fat mixture or emulsion when spread. Said fat mixture can be applied on cold and hot foodstuffs without losing the texture and structure.

Said fat mixture is suitable for a wide range of food products and applications. Examples of applications are use as mayonnaise and in food products containing mayonnaise, as well as sauces, seasoning sauces, dressings, gravies, topping, glazings, puddings, etc.

The following examples are illustrative of embodiments of the present invention, as described above, and they are not meant to limit the invention in any way.

### EXAMPLES

### Example 1

### Manufacture of Quark

10 000 L of a solution comprising milk raw material and having a protein content of 3.7 wt % was stirred and pasteurized at a temperature of 87° C. for 7 minutes.

After pasteurization, the solution was cooled to a temperature of about 29° C., where a plate heat exchanger was used in cooling.

An acidifier (starter culture) and lactase enzyme were added to the cooled solution. The pH of the acidified and lactose hydrolyzed solution decreased to a level of about 4.5 during a period of time of 15 to 20 hours to provide curd mixture. The curd mixture was then stirred.

The curd mixture was further processed to quark as follows: The curd mixture was thermized on a plate heat exchanger at a temperature of 63° C. After thermization, the curd mixture was cooled to 43° C. and sieved. Subsequently, the curd mixture was subjected to separation where quark mass was separated from solution by a quark separator (a plate & frame ultrafiltration apparatus). 3040 L of quark mass was obtained. The quark mass having total solids of about 15 wt % was cooled to 13° C. The protein content of the quark mass was 10.1 wt % and lactose content was 3 wt %. Quark mass having total solids of about 27% was cooled to 13° C.

### Example 2

### Manufacture of Acidified Milk Base

### Example 2.1

40 wt % of skim milk and 60 wt % of UF-milk (ultra-filtrated milk concentrate) were mixed. The mixture was then pasteurized at 85° C. for 3-4 minutes. The milk base was cooled to 30° C. and 0.1 wt % of starter culture (YO MIX) was added. The blend was mixed for 10 minutes and fermented at 35-45° C. for about 5.5-6 hours or until pH was about 4.9. The acidified milk base was mixed and cooled to a temperature of 13° C.

### Example 2.2

1800 g of UF milk concentrate and 1200 g of skim milk was mixed. The mixture was pasteurized at 85° C. for 5 minutes and then cooled to 42° C. 1.5 g of starter (YO MIX) was added to the blend and incubated/fermented at 42° C. until pH 4.5-4.9 was attained. Finally the acidified milk base was cooled to about 13° C.

### Example 3

### Manufacture of Acidified Milk Base Comprising Casein Concentrate

2400 g of casein concentrate (5-11 wt % protein) and 600 g of skim milk was mixed. The mixture was pasteurized at 85° C. for 5 minutes and then cooled to 42° C. 1.5 g of starter (YO MIX) was added to the blend and incubated/fermented until pH 4.9 was attained. Finally the acidified milk base was cooled to about 13° C.

### Example 4

### Manufacture of Fat Mixture

### Example 4.1

Quark blend was manufactured by mixing 73 wt % of quark and 27 wt % of acidified milk base (from example 2.1). 1000 g (50 wt %) of this quark blend and 1000 g (50 wt %) of rapeseed oil was mixed and/or homogenized (using Ytron Pilot Blender) to obtain smooth white fat mixture. The proteins consisted of about 95% casein and about 5% whey protein. Total fat content was about 50 wt % and lactose content <0.01 wt %. The pH of the fat mixture was 4.5-5. The milk fat content was <0.2 wt %.

### Example 4.2

In one embodiment 5000 g of quark and 5000 g of acidified milk base containing casein concentrate (from example 3) was mixed. 5000 g of rapeseed oil was added and mixed using blender. The resulting fat mixture was smooth, white, thick, glossy emulsion with a pleasant mouth feel and taste. The pH of the fat mixture was about 4.9. The fat mixture consisted of about 33 wt % fat and 6.3 wt % protein. The milk fat content was <0.2 wt %.

### Example 4.3

In one embodiment 730 g quark and 270 g of acidified milk base (from example 2.2) was mixed. 500 g rapeseed oil was added and mixed with a blender. The resulting fat mixture was smooth, white, thick, glossy emulsion with a pleasant mouth feel and mild taste. The pH of the fat mixture was about 4.9-5. The fat mixture consisted of about7 wt % protein and 33 wt % fat. The milk fat content was <0.3 wt %.

### Example 4.4

In one embodiment the fat mixture was prepared by mixing 5000 g quark, 5000 g acidified (from example 3) milk base and 7000 g rapeseed oil. At first quark and acidified milk base were mixed to obtain a quark blend, oil was preheated to room temperature and added to the quark blend with a blender. The resulting fat mixture was white, smooth emulsion with a pleasant mouth feel, taste and stabile texture. The resulting fat mixture contained 41 wt % oil and 59 wt % quark blend. The fat mixture consisted of 41 wt % fat and 6 wt % protein. The pH of the fat mixture was 4.9. The milk fat content was <0.2 wt %

### Example 4.54

In still another embodiment the fat mixture was prepared by mixing 73 g of quark (11wt % protein, <0.3 wt % fat and 3 wt % lactose) and 27 g of acidified milk base (from example 2.2) was mixed with a blender. 100 g of olive oil was added and mixed with a blender. The resulting fat mixture was white, glossy, thick emulsion with a pleasant mouth feel. The fat mixture comprised of 50 wt % fat and 5 wt % proteins. The milk fat content was <0.15 wt %.

The present invention has been described herein with reference to specific embodiments. It is, however clear to those skilled in the art that the process(es) may be varied within the bounds of the claims.

1. A process for the manufacture of a fat mixture, characterized in that said process comprises the steps where in the first step 60-95 wt % of quark and 5-40 wt % of milk base are mixed to obtain a quark blend, said percentages being calculated from the quark blend, in the second step 9-62 wt % of edible plant oil, calculated from the total weight of the fat mixture, is added to 38-91 wt % of the quark blend, calculated from the total weight of the fat mixture, followed by mixing to obtain the fat mixture, and where 0-50 wt % of the quark is replaced with casein concentrate.

2. The process according to claim 1, characterized in that the amount of quark is 70-75 wt %.

3. The process according to claim 1, characterized in that the amount of the milk base is 25-30 wt %.

4. The process according to claim 1, characterized in that the amount of the edible plant oil is 44-60 wt %.

5. The process according to claim 1, characterized in that the amount of the quark blend is 40-65 wt %.

6. The process according to claim 1, characterized in that the milk base is selected from non-acidified milk bases and acidified milk bases and combinations thereof, preferably from acidified milk bases.

7. The process according to claim 1, characterized in that the milk base comprises skim milk, UF-milk, NF-milk, casein concentrate, UF-retentate, NF-retentate, ideal whey solution, or a combination thereof, preferably said milk base is acidified.

8. The process according to claim 1, characterized in that the plant oil is selected from sunflower oil, rapeseed oil, soy bean oil, cotton seed oil, palm kernel oil, peanut oil, olive oil, maize oil, corn oil, walnut oil, sesame oil, linseed oil, avocado oil, pecan oil, colza oil, almond oil, camelina oil, safflower oil, hempseed oil, pumpkin seed oil and any combinations thereof.

9. The process according to claim 1, characterized in that the mixing is carried out with a homogenizer, jet mixer, jet mixing turbine, emulsifier, high shear emulsifier or power blender.

10. The process according to claim 1, characterized in that the mixing is carried out at a temperature of 2-30° C.

11. The process according to claim 1, characterized in that one or more additives selected from salt, sweeteners, acetic acid, vinegar, aromas, spices, flavors, seasonings, cocoa, mustard, coloring agents, tomato, sweet pepper, vitamins, antioxidants, preservatives are added to the fat mixture.

12. The process according to claim 1, characterized in that the pH of the fat mixture is adjusted to 3-6.5 with vinegar, acidified milk base, glucono delta lactone, lemon juice, lactic acid, citric acid, hydrochloric acid, oxalic acid, tartaric acid, fumaric acid, succinic acid, malic acid, gluconic acid, adipic acid, phytic acid or another food grade acid, and any combinations thereof.

13. A fat mixture, characterized in that said fat mixture comprises 1-12 wt % of proteins calculated as total proteins, 9-62 wt % of edible plant oil, 0-2 wt % of butterfat and at least 50 wt % of said proteins comprise casein and 0.1-10 wt % of said proteins comprise native whey proteins, and the pH of the fat mixture is 3-6.5.

14. The fat mixture according to claim 13, characterized in that the fat mixture comprises 2-10 wt % of proteins.

15. The fat mixture according to claim 13, characterized in that the fat mixture comprises 0.2-4 wt % of native whey proteins.

16. The fat mixture according to claim 13, characterized in that the fat mixture comprises 44-60 wt % of edible plant oil.

17. The fat mixture according to claim 13, characterized in that the fat mixture comprises 0-5 wt % of lactose, preferably 0.005-4.3 wt % of lactose.

18. The fat mixture according to claim 13, characterized in that 90-96 wt %, preferably 93-96 wt % of the proteins, calculated as total proteins, comprise casein.

19. The fat mixture according to claim 13, characterized in that the fat mixture comprises one or more additives selected from salt, sweeteners, acetic acid, vinegar, aromas, spices, flavors, seasonings, cocoa, mustard, coloring agents, tomato, sweet pepper, vitamins, antioxidants and preservatives.

20. A food product comprising the fat mixture according to claim 13.

21. Use of the fat mixture according to claim 13 in the manufacture of food products.
